(19) United States
(12) Patent Application Publication
(10) Pub. No.: US 2002/0171623 A1
(43) Pub. Date: Nov. 21, 2002

(54) Maneuvering device

(76) Inventor: Shoei Lai Chen, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/858,646

(22) Filed: May 17, 2001

(51) Int. Cl. G09G 5/00

(52) U.S. Cl. 345/156; 345/163

(57) ABSTRACT

The present invention provides a maneuvering device comprising a control circuit, a laser maneuvering key, a mode switching key, a maneuvering part, a laser light-emitting device, a light-emitting device, a mode light-emitting device, and a shell body. The maneuvering part is capable of selectively paging up/down or scrolling. The laser maneuvering key, the mode switching key, the maneuvering part, the laser light-emitting device, the light-emitting device, and the mode light-emitting device are disposed on the shell body and are connected with the control circuit. Thereby, a user can use the maneuvering device to directly remote-control a notebook computer to page up/down or scroll.

### FIELD OF THE INVENTION

The present invention relates to a maneuvering device and, more particularly, to an emitter having functions of laser pointing, sound recording, and directly remote-controlling a notebook computer to page up/down or scroll.

### BACKGROUND OF THE INVENTION

Generally speaking, when making a briefing in a company or a conference room, the speaker usually needs to carry a notebook computer matched with a video apparatus such as an overhead projector or a liquid crystal display (LCD) monitor. If the content on the screen is to be scrolled or be paged up/down, he must operate the keyboard of the notebook computer to achieve this function.

However, the notebook computer is generally connected with the overhead projector through a signal line. Therefore, there is usually a large distance between the speaker and the notebook computer, resulting in much inconvenience to the speaker.

An assistant can operate the notebook computer to help the speaker. That is, when the content is to be scrolled or be paged up/down, the speaker must inform the assistant to operate the notebook computer. If the distance is too large, a microphone is utilized by the speaker to inform the assistant.

However, not all speakers have assistants available. If the speaker has no assistant, the briefing efficiency will be reduced, hence greatly deteriorating its effect.

Accordingly, the present invention aims to provide a maneuvering device, which can send out wireless signals to remotely control a notebook computer to page up/down or scroll.

### SUMMARY OF THE INVENTION

One object of the present invention is to provide a maneuvering device, wherein a laser maneuvering key, a mode switching key, a maneuvering part, a laser light-emitting device, a light-emitting device, and a mode light-emitting device are disposed on a shell body and connected with a control circuit. Through the program operation of the parts and the control circuit of the maneuvering device, a user can directly remote-control a notebook computer to page up/down or scroll.

Another object of the present invention is to provide a maneuvering device having functions of laser pointing, sound recording, and directly remote-controlling a notebook computer to page up/down or scroll, thereby preventing a speaker from much inconvenience.

The various objects and advantages of the present invention will be more readily understood from the following detailed description when read in conjunction with the appended drawings, in which:

### BRIEF DESCRIPTION OF THE DRAWINGS:

FIG. 1 is a perspective view of the present invention;

FIG. 2 is a circuit diagram of the present invention;

FIG. 3 is a program flowchart of a control circuit of the present invention;

FIG. 4 is an application diagram according to an embodiment of the present invention;

FIG. 5 is an application diagram according to another embodiment of the present invention;

FIG. 6 is a circuit diagram related to the internal composition of the receiver shown in FIG. 4; and

FIG. 7 is a program flowchart of the USB controller shown in FIG. 6.

### DETAILED DESCRIPTION OF THE PREFERRED EMBODIMENTS

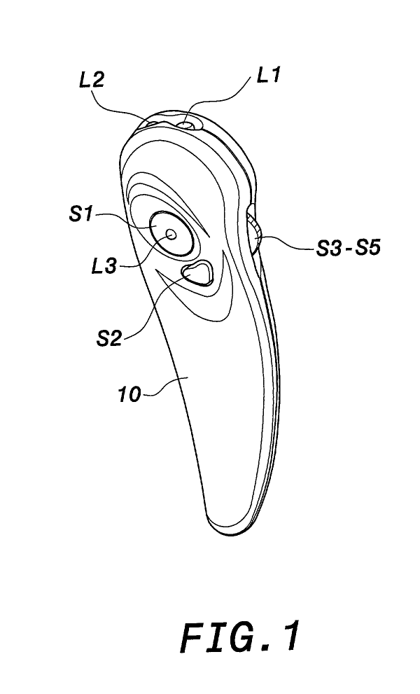

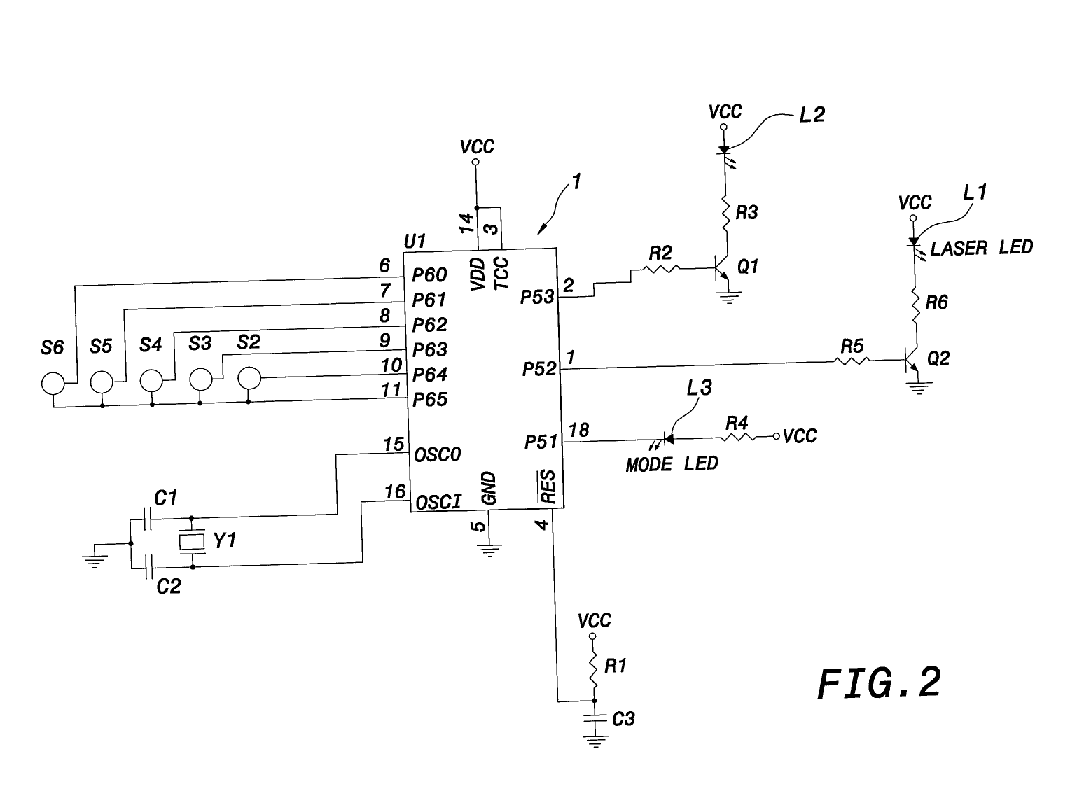

As shown in FIGS. 1 and 2, the present invention proposes a maneuvering device comprising a control circuit 1, a laser maneuvering key S1, a mode switching key S2, a maneuvering part S3-S5, a laser light-emitting device L1, a light-emitting device L2, and a mode light-emitting device L3.

The control circuit 1 is disposed in a shell body 10, and is formed by connecting a microprocessor U1, a quartz crystal Y1, capacitors C1 to C3, a resistor R1, transistors Q1 and Q2, and so on. The laser light-emitting device L1 and the light-emitting device L2, which are connected to the control circuit 1, are disposed at the front edge of the shell body 10. The circular laser maneuvering key S1 is connected to the control circuit 1, and is disposed on the front side face of the shell body 10.

When the laser maneuvering key S1 is pressed, the microprocessor U1 of the control circuit 1 will drive the transistor Q2 to conduct, hence letting the laser light-emitting device L1 be on. Otherwise, the laser light-emitting device L1 will be off. The mode light-emitting device L3 is connected to the control circuit, and is disposed on the laser maneuvering key S1. The mode switching key S2 is connected to the microprocessor U1 of the control circuit 1, and is disposed below and near the laser maneuvering key S1. When the mode switching key S2 is pressed, the microprocessor U1 will drive the mode light-emitting device to be on or off.

The maneuvering part S3-S5, a turning wheel in an embodiment of the present invention, capable of paging up/down or scrolling is disposed on a side face of the shell body 10. The maneuvering part S3-S5 is connected to the microprocessor U1 of the control circuit 1.

There are two modes for the operation of the maneuvering part S3-S5. Mode 1: when the mode light-emitting device L3 is off, and the maneuvering part S3 (S4) is pressed upwards (or downwards), the function of paging up (or down) is performed. Mode 2: when the mode light-emitting device L3 is on, and the maneuvering part S5 is pressed downwards, the function of scrolling is performed.

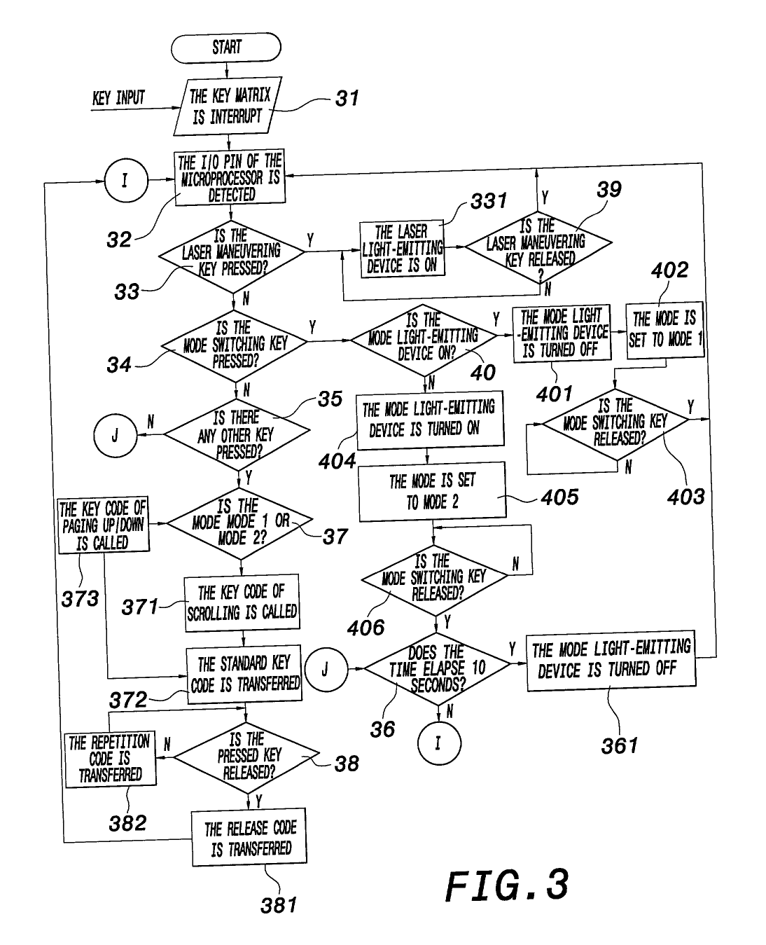

Please refer to FIG. 3, which shows a program flowchart of the control circuit. Once starting, the key matrix is interrupt (31), the I/O pin of the microprocessor is detected (32), and whether the laser maneuvering key is pressed is judged (33).

If the laser maneuvering key is pressed, the laser light-emitting device will be turned on (331), and whether the laser maneuvering key is released will be judged (39). If the laser maneuvering key is released, the step 32 is jumped back to; otherwise, the step 331 is jumped back to. If the laser maneuvering key is not pressed, whether the mode switching key is pressed is judged (34).

If the mode switching key is not pressed, whether any other key is pressed is judged (35).

If no other key is pressed, whether the waiting time elapses 10 seconds is judged (36). If the waiting time does not elapse 10 seconds, the step 32 is jumped back to; otherwise, the mode light-emitting device will be turned off (361), and the step 32 is then jumped back to.

If some other key is pressed, whether the mode is Mode 1 or Mode 2 is judged (37).

If the mode is Mode 1, the key code of scrolling is called (371), the standard key code is transferred (372), and whether the pressed key is released is judged (38). If the mode is Mode 2, the key code of paging up/down is called (373), and the step 372 is performed.

If the pressed key is released, the release code is transferred (381), and the step 32 is then jumped back to; otherwise, the repetition key is transferred (382), and the step 38 is then jumped back to.

If the mode switching key is pressed, whether the mode light-emitting device is on is judged (40).

If the mode light-emitting device is on, the mode light-emitting device will be turned off (401), the mode will be set to Mode 1, and whether the mode switching key is released will be judged (403). If the mode switching key is released, the step 32 is jumped back to; otherwise, the step 403 is repeated.

If the mode light-emitting device is off, the mode light-emitting device will be turned on (404), the mode will be set to Mode 2, and whether the mode switching key is released will then be judged (406). If the mode switching key is released, the step 36 is jumped to; otherwise, the step 406 is repeated.

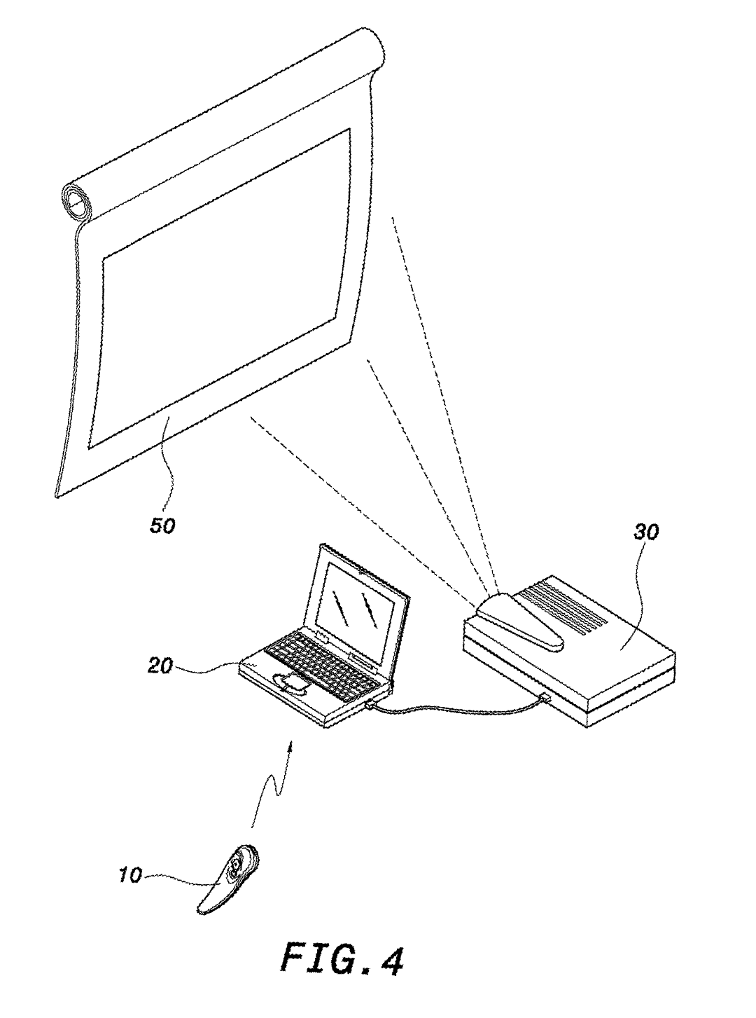

Please refer to FIG. 4. When a notebook computer 20 receives wireless signals from the maneuvering device, it will drive an overhead projector 30 to perform corresponding functions, letting the content displayed on a screen 50 page up/down or scroll.

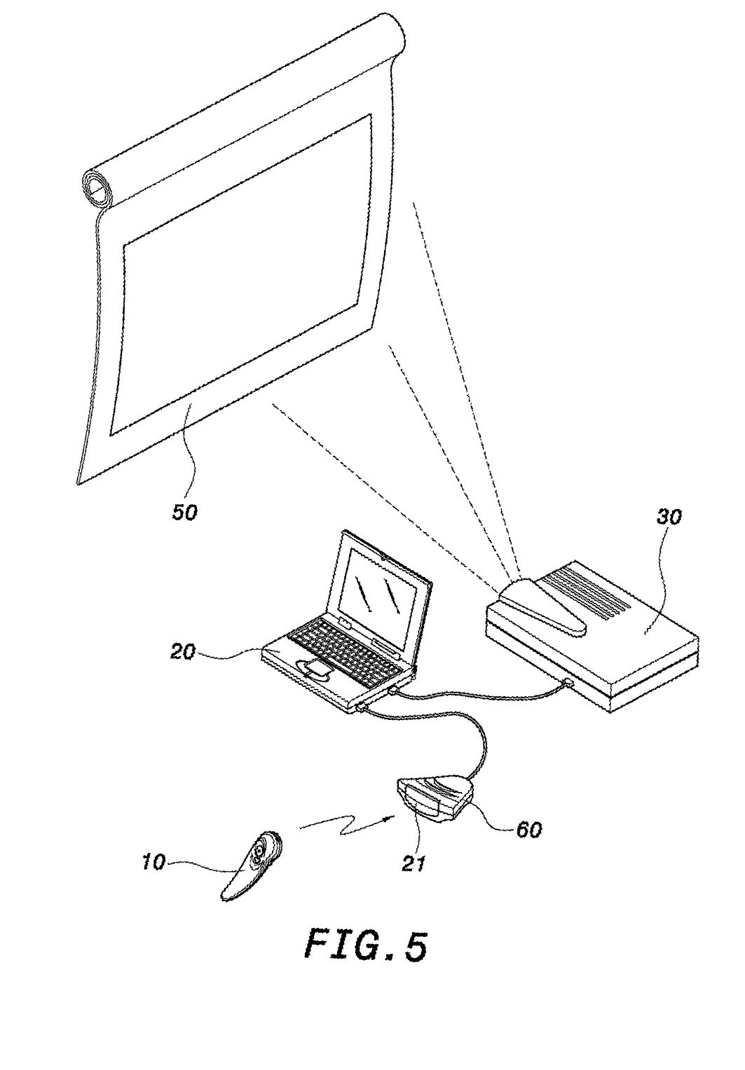

Please refer to FIG. 5. When a receiver 60 receives wireless signals from the maneuvering device, it will decode the signals and then transfer to the notebook computer to perform corresponding functions, letting the content displayed on a screen 50 page up/down or scroll.

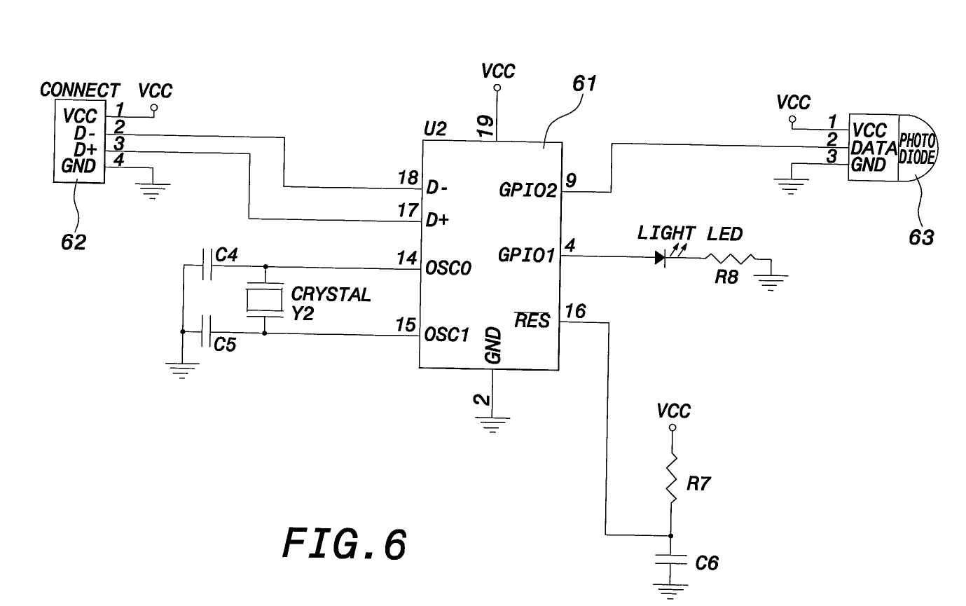

FIG. 6 is a circuit diagram related to the internal composition of the receiver 60, which has a universal serial bus (USB) controller 61 formed by connecting a USB chip U2, a quartz crystal Y2, capacitors C4 and C5, and so on. The USB controller 61 is connected to a USB port of the notebook computer 20 through a connector 62. The USB controller 61 is also connected with a receiving circuit 63.

When the receiving circuit 63 receives wireless signals from the maneuvering device, it will transfer the signals to the USB chip U2 for decoding. The decoded data is then transferred to the notebook computer 20.

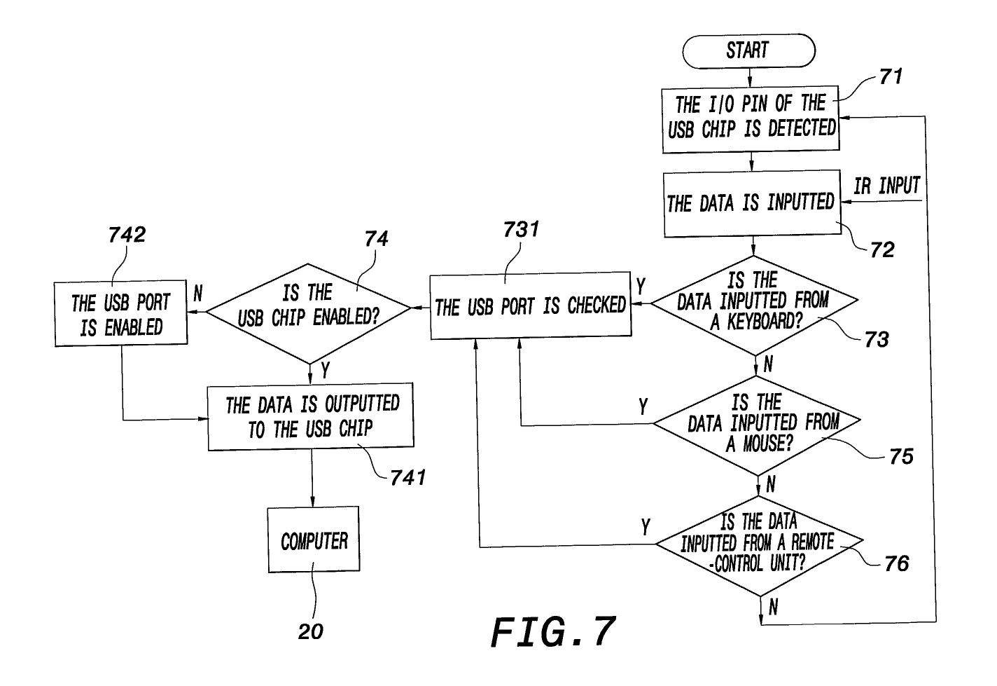

Please refer to FIG. 7, which is a program flowchart of the USB controller. Once starting, the I/O pin of the USB chip U2 is detected (71), the data is inputted (72), and whether the data is inputted from the keyboard is judged (73).

If the data is inputted from the keyboard, the USB port is checked (731), and whether the USB chip is enabled is judged (74). If the USB chip is enabled, the data will be outputted to the USB chip (741) and then to the notebook computer; otherwise, the USB port will be initiated (742), and the data will be outputted to the USB chip (741) and then to the notebook computer.

If the data is not inputted from the keyboard, whether the data is inputted from the mouse is judged (75).

If the data is inputted from the mouse, the step 731 is performed; otherwise, whether the data is inputted from a remote-control unit is judged (76).

If the data is inputted from a remote-control unit, the step 731 is performed; otherwise, the step 71 is jumped back to.

Additionally, in the present invention, a circuit (not shown) having sound-recording function can be added in the shell body 10. The circuit is operated through a switching key so that the user can record sound.

To sum up, through special design, the present invention has the following characteristics.

(1). The maneuvering device can send out wireless signals to directly remote-control a notebook computer to page up/down or scroll.

(2). The present invention also has functions of laser pointing and sound recording.

(3). The present invention can prevent the speaker from much inconvenience.

Although the present invention has been described with reference to the preferred embodiments thereof, it will be understood that the invention is not limited to the details thereof. Various substitutions and modifications have been suggested in the foregoing description, and others will occur to those of ordinary skill in the art. For instance, wireless signals sent out by the light-emitting device can be replaced with infrared (IR) signals or radio-frequency (RF) signals. Therefore, all such substitutions and modifications are intended to be embraced within the scope of the invention as defined in the appended claims.

I claim:

1. A maneuvering device comprising:
a shell body;
a mode switching key disposed on said shell body;
a mode light-emitting device disposed on said shell body, said mode light-emitting device being matched with the operation of said mode switching key to be on or off;
a maneuvering part disposed on said shell body, said maneuvering part being used to selectively page up/down or scroll;
a light-emitting device disposed on said shell body; and
a control circuit disposed in said shell body and connected with said maneuvering part, said mode switching key, said mode light-emitting device, and said light-emitting device, said control circuit performing corresponding functions according to the input states of said mode switching key and said maneuvering part and sending out wireless signals through said light-emitting device;
whereby said maneuvering device can directly remote-control a computer to page up/down or scroll.

2. The maneuvering device as claimed in claim 1, wherein a laser maneuvering key and a laser light-emitting device can be disposed on said shell body to let said maneuvering device have also laser pointing function.

3. The maneuvering device as claimed in claim 1, wherein a circuit having sound-recording function can be added in said shell body, and said circuit is operated through a switching key.

4. The maneuvering device as claimed in claim 1, wherein said mode light-emitting device is on when said maneuvering part switches to the action of scrolling and is off when said maneuvering part switches to the action of paging up/down.

5. The maneuvering device as claimed in claim 1, wherein said maneuvering part can be a turning wheel.

6. The maneuvering device as claimed in claim 1, wherein the wireless signals sent out by said light-emitting device can be infrared or radio-frequency signals.

7. The maneuvering device as claimed in claim 1, wherein the wireless signals sent out by said light-emitting device can be received by a receiver and then decoded and transferred to the computer.

8. The maneuvering device as claimed in claim 7, wherein said receiver comprises:
a receiving circuit for receiving wireless signals sent out by a keyboard, a mouse, or a remote-control unit;
a universal serial bus controller connected to said receiving circuit to decode the signals outputted by said receiving circuit and then output the decoded data; and
a connector for connecting said universal serial bus controller and the computer to transfer the output data from said universal serial bus controller to the computer.
